(19) United States
(12) Patent Application Publication
(10) Pub. No.: US 2018/0335067 A1
(43) Pub. Date: Nov. 22, 2018

(54) FASTENER WITH TIGHTENING TIP

(71) Applicant: OMCO Solar, LLC, Phoenix, AZ (US)

(72) Inventor: Todd Owen, Litchfield Park, AZ (US)

(73) Assignee: OMCO Solar, LLC, Phoenix, AZ (US)

(21) Appl. No.: 15/599,392

(22) Filed: May 18, 2017

(51) Int. Cl. F16B 23/00

(52) U.S. Cl. CPC F16B 23/0092; F16B 23/0007

(57) ABSTRACT

A threaded fastener is provided that is structured to permit tightening at either the top end (the head) or the bottom end (tip) of the fastener. The fastener comprises a threaded shaft, a head disposed on a first distal end of the threaded shaft, and a tip disposed on a second distal end of the threaded shaft. The tip and the head are structured to fit standard wrenches.

### BACKGROUND OF THE INVENTION

### 1. Field of the Invention

The present invention relates to a threaded fastener that is structured to permit tightening at either the top end (the head) or the bottom end (tip) of the fastener.

### 2. Description of the Related Art

Threaded fasteners include various types of bolts and screws. Typically, a threaded fastener is used to join components or hold parts of a device together.

Threading comprises an external helical structure that is used to convert rotational motion to linear motion when the fastener is tightened. Typically, a threaded fastener is tightened by turning the head of the fastener in a clockwise direction. The threaded fastener can be un-tightened (loosened) by turning the head in a direction opposite of the one used for tightening.

Although threaded fasteners are widely used, there are situations where access to the head is rather difficult. For example, in many automobiles, the engine components are housed together in close proximity making access to certain bolts and screws problematic. Several parts that are in the way may have to be removed to obtain access to a bolt head. As another example, in the construction of photoelectric array structures, it can be difficult to access bolts from the top of the structure.

### SUMMARY OF THE INVENTION

A threaded fastener is provided that is structured to permit tightening at either the top end (the head) or the bottom end (tip) of the fastener. The fastener comprises a threaded shaft, a head disposed on a first distal end of the threaded shaft, and a tip disposed on a second distal end of the threaded shaft. The tip and the head are structured to fit standard wrenches.

### BRIEF DESCRIPTION OF THE DRAWINGS

FIG. 1 illustrates a perspective view of a threaded fastener with tightening tip, according to an embodiment.

FIG. 2 illustrates a side view of the threaded fastener of FIG. 1.

FIG. 3 illustrates a top plan view of the threaded fastener of FIG. 1.

FIG. 4. illustrates a bottom plan view of the threaded fastener of FIG. 1 showing a tip of the fastener.

FIG. 5A-5C illustrate various other types of tips that are useable for the threaded fastener, according to other embodiments.

FIG. 6 illustrates an exemplary clamp that uses the fastener of claim 1.

### DETAILED DESCRIPTION OF THE INVENTION

Details of the various embodiments of the present invention will now be discussed by reference to the drawings.

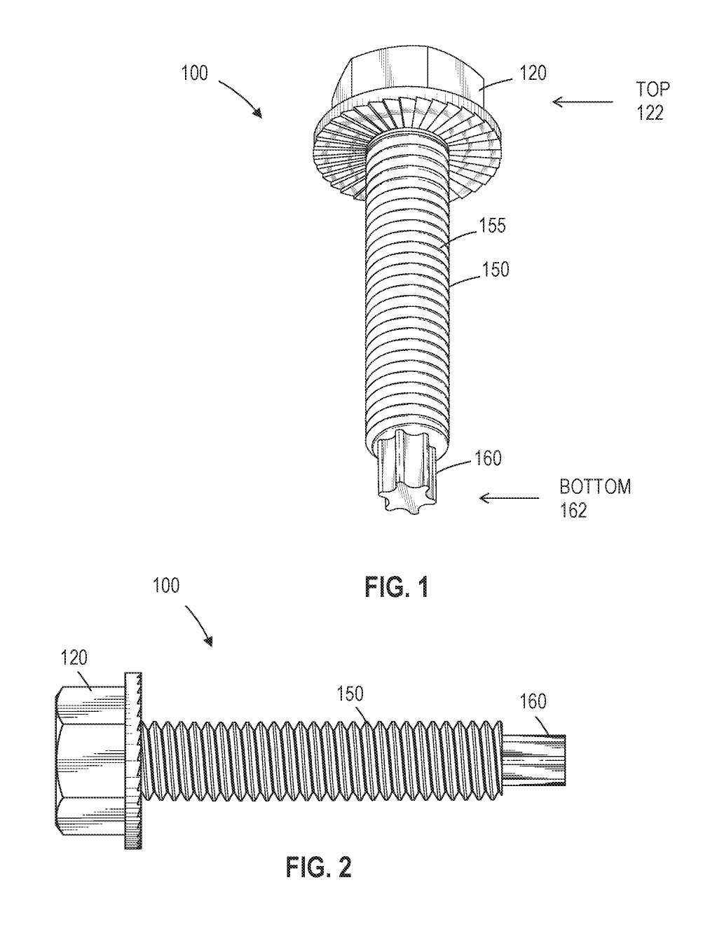

Referring to FIG. 1, a perspective view of a fastener device 100, according to an embodiment, is illustrated. FIG. 2 shows a side view of the same fastener device 100. As depicted, the fastener device 100 includes a shank 150, a head 120 and a tip 160. The head 120 is disposed on a first distal end 122 (the “top”) of the shank 150, and the tip 160 is disposed on a second distal end 162 (the “bottom”) of the shank 150. As illustrated, the head 120 is greater in width than the shank 150.

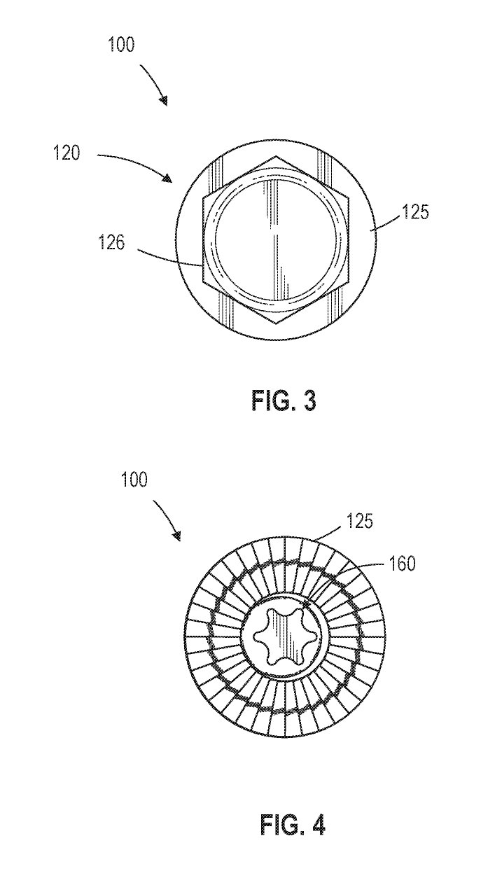

FIG. 3 shows a top plan view of the head 120. As illustrated, the head 120 includes a hexagonal shaped portion 126 and an indented circular bearing surface portion 125. Notably, the hexagonal shaped portion 126 fits a standard socket wrench. In the illustrated embodiment, the socket wrench chosen would have a hexagonal socket conforming to the size (e.g., 16 mm) of the hexagonal shaped portion 126. Other types of wrenches, such as an open wrench or an adjustable wrench could also be used so long as they were of the proper size. It is to be understood that other shapes, sizes, and types of standard bolt heads could be used depending on the application and other requirements.

Referring again to FIGS. 1-2, the shank 150 includes threading 155. In a preferred embodiment, the threading 155 is right-handed threading allowing the fastener 100 to be tightened by turning the head 120 in a clockwise manner. Alternatively, the threading 155 could be left-handed threading allowing the fastener 100 to be tightened by turning the head 120 in a counter-clockwise manner. The fastener can be untightened (loosened) by turning the head in a direction opposite to the one used for tightening. The pitch and other characteristics of the threading 155 will vary depending on the application and other requirements.

As illustrated, and notably, the tip 160 is structured to fit a standard star socket receptacle such as a TORX head socket. As shown, the star structure has six points, and conforms to an E6 type TORX socket. For reference, see International Organization for Standardization (ISO) 10664:2014 that specifies the shape and basic dimensions of the hexalobular internal driving feature for bolts and screws. According to an embodiment, the tip 160 fits a TORX socket with minimal tolerances. In an embodiment, the tip conforms to the above-mentioned ISO standard with minimal tolerances.

As mentioned, the fastener 100 can be tightened by rotating the head 120 in a certain direction (e.g., clockwise if the threading 155 is right-handed). However, the fastener can alternatively be tightened by rotating the tip 160. More particularly, the user can employ wrench from the bottom of the fastener 100. In this case, the fastener 100 is tightened by rotating the tip 160 in a direction opposite to the one used for tightening the fastener 100 when the head is rotated. Thus, for example, if the threading 155 is right-handed, the fastener 100 can be tightened by either rotating the head 120 in a clockwise manner or the tip 160 in a counter-clockwise manner.

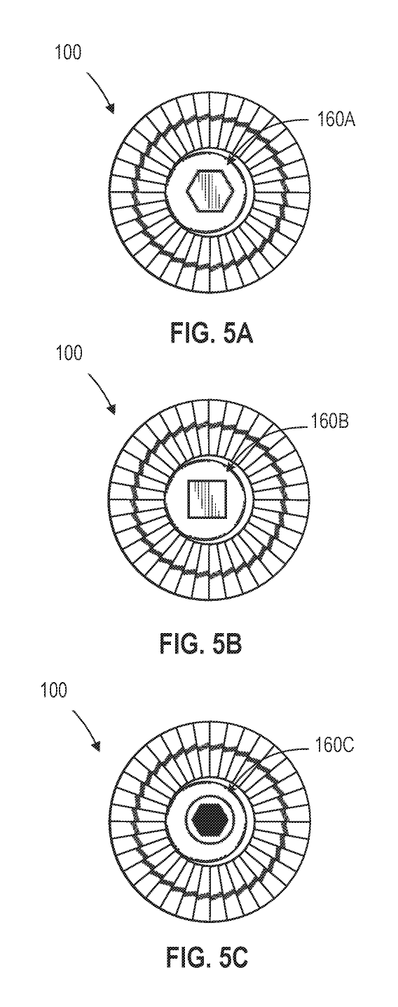

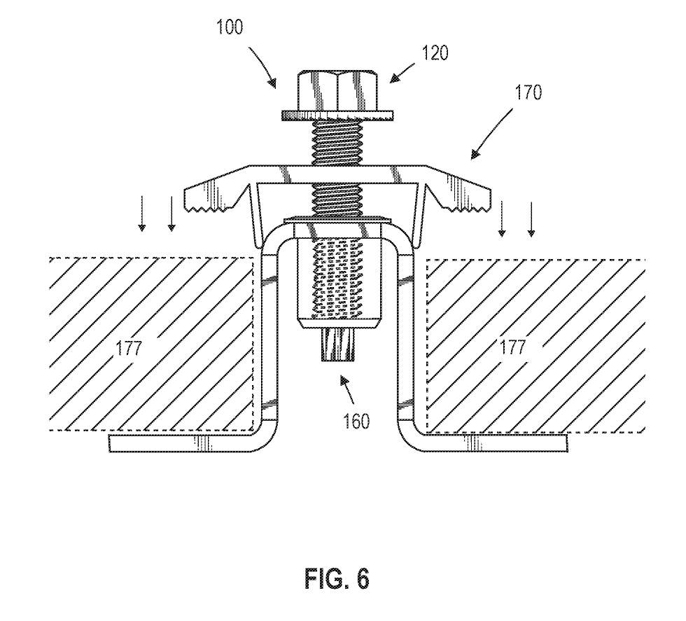

FIGS. 5A-5C illustrate various other types of tips that are useable for the threaded fastener 100, according to other embodiments. These alternative tips are different from the tip 160 in that the shapes conform to other types of standard wrench sockets. For example, FIG. 5A shows a hexagonal shaped tip 160A that conforms to a standard hexagonal socket wrench. FIG. 5B shows a square shaped tip 160B that conforms to a square-shaped socket wrench. FIG. 5C shows an indented hexagonal shaped tip 160C that conforms to a standard indented hexagonal socket wrench. It is to be understood that various other types of tips could be used so long as they conform to standard wrench sockets. Accordingly, the tips shown herein are provided for illustrative purposes and are not meant to be an exhaustive list.

FIG. 6 illustrates an example clamp 170 that employs the fastener 100. It is to be understood that the example clamp 170 is presented herein for expository purposes and is not meant to be a limiting example of the various uses for the fastener 100. The clamp 170 is used to secure photovoltaic modules 180 that are arranged side-by-side along railing 177. As shown, the clamp 170 is shown in an “open” position. When the fastener 100 is tightened, the rotational motion of the fastener 100 is converted to downward linear motion causing the clamp grips 172 to eventually press onto the upper sides 180t of the photovoltaic modules 180. Advantageously, the fastener 100 can be tightened either by using a hexagonal wrench at the head 120 from the top of the clamp 170 or star socket wrench (e.g., a TORX wrench) at the tip 160 from the bottom of the clamp 170.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A fastener, comprising:
a threaded shaft;
a head disposed on a first distal end of the threaded shaft; and
a tip disposed on a second distal end of the threaded shaft;
wherein the head is greater in width than the threaded shaft; and
wherein the tip and the head are structured to fit standard wrenches.

2. The fastener of claim 1, wherein the head is greater in width than the tip.

3. The fastener of claim 1, wherein the tip is structured to fit a star head wrench.

4. The fastener of claim 1, wherein the head is structured to fit a hexagonal wrench.

5. The fastener of claim 1, wherein the tip is structured to fit a square head wrench.

6. The fastener of claim 1, wherein the tip is structured to fit a hexagonal wrench.

7. The fastener of claim 1, wherein the tip is no wider than the threaded shaft.

8. The fastener of claim 1, wherein a wrench socket that fits the head is larger in size than a wrench socket that fits the tip.

9. The fastener of claim 1, wherein the threaded shaft includes right handed threading allowing the fastener to be tightened by turning the head in a clockwise manner.

10. The fastener of claim 9, wherein the threaded shaft includes right handed threading allowing the fastener to be tightened by turning the tip in a clockwise manner.
